(19) United States
(12) Patent Application Publication
(10) Pub. No.: US 2007/0206689 A1
(43) Pub. Date: Sep. 6, 2007

(54) METHOD AND APPARATUS FOR CHANNEL ESTIMATION IN AN ORTHOGONAL FREQUENCY DIVISION MULTIPLEXING SYSTEM

(75) Inventors: Chang-Soo Koo, Melville, NY (US); Eldad M. Zeira, Huntington, NY (US); I-Tai Lu, Dix Hills, NY (US); Robert Lind Olesen, Huntington, NY (US); Kun-Ju Tsai, Forest Hills, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/680,959

(22) Filed: Mar. 1, 2007

Related U.S. Application Data
(60) Provisional application No. 60/777,879, filed on Mar. 1, 2006.

(51) Int. Cl. H04K 1/10

(52) U.S. Cl. 375/260

(57) ABSTRACT

In an orthogonal frequency division multiplexing (OFDM) system, a frequency domain channel estimate for non-nullified subcarriers is converted to a time domain channel estimate. The number of taps L of a channel model is determined based on the time domain channel estimate. An improved time domain channel estimate is obtained by computing L tap coefficients of the channel model from the frequency domain channel estimate. An improved frequency domain channel estimate is obtained by performing a Fourier transform on the improved time domain channel estimate. Alternatively, a time domain truncation method may be performed selectively only if the signal-to-noise ratio (SNR) is below a threshold. Alternatively, a frequency domain channel estimate for pilot subcarriers are converted to a time domain channel estimate and an improved frequency domain channel estimate is obtained based on the number of pilot subcarriers and a delay spread.

### CROSS REFERENCE TO RELATED APPLICATION

This application claims the benefit of U.S. provisional application No. 60/777,879 filed Mar. 1, 2006, which is incorporated by reference as if fully set forth.

### FIELD OF INVENTION

The present invention is related to wireless communication systems. More particularly, the present invention is related to a method and apparatus for channel estimation in an orthogonal frequency division multiplexing (OFDM) system.

### BACKGROUND

OFDM technology has been adopted in several wireless communication standards, such as IEEE 802.11 a/g/n and HIPERLAN. OFDM techniques have a merit of high spectral efficiency since adjacent OFDM sub-carriers may share the same spectrum while still remain orthogonal to each other.

A receiver requires a signal-to-noise ratio (SNR) and channel information prior to decoding data, (e.g., for minimum mean square error (MMSE) decoding). Therefore, channel estimation directly affects the performance of the receiver in terms of a packet error rate (PER), a bit error rate (BER), or the like.

Multiple-input multiple-output (MIMO) techniques have a merit of high throughput, since MIMO provides multiple orthogonal eigen-channels which facilitate the transmission of multiple spatial streams for each pair of transceivers. In MIMO systems, the information of the channel matrix is essential for decoding transmitted data correctly. If the channel matrix is not estimated accurately, the eigen-channels cannot be fully decoupled at the receiver and the spatial streams may be coupled, which results in inter-spatial stream interference (ISSI). As a channel estimation error increases, the ISSI, and consequently the PER and BER, increases.

In a conventional wireless communication system, the channel is usually estimated in a frequency domain. However, when the coherent bandwidth of the channel is larger than the signal bandwidth, (e.g., in an indoor wireless local area network (WLAN) environment), it is more advantageous to estimate the channel in a time domain than in a frequency domain.

For example, 64 sub-carriers are used in the 20 MHz mode of an IEEE 802.11n standard. Using a preamble, the receiver estimates the channel transfer functions for 56 out of 64 sub-carriers. For small indoor environments, the delay spreads are very small. For example, the delay spread is only 90 nsec for the TGn B channel. Each channel would require only 2 to 3 taps in the time domain channel model because the sampling interval is fixed at 50 nsec. Thus, a time-domain channel estimation will be far more efficient than a frequency domain channel estimation in terms of mitigating the noise effects on channel estimation.

A time domain truncation (TDT) method has been proposed for improving the channel estimation. In a conventional TDT method, channel transfer functions are obtained for all sub-carriers using a conventional channel estimation method such as a maximum likelihood (ML) technique. A channel impulse response in the time domain is then derived by applying an inverse Fourier transform on the channel transfer functions in the frequency domain. Subsequently, the impulse response is truncated to remove noisy elements of the channel impulse response in the time domain. Finally, a Fourier transform is performed on the truncated channel impulse response to yield an improved channel transfer function in the frequency domain.

The conventional TDT method works well for channels with short delay spreads. However, it requires initial channel estimation for all sub-carriers. If there are null sub-carriers, the TDT approach will induce channel estimation errors. The null subcarrier-induced errors may be small compared to the noise-induced errors when the SNR of the channel is low. However, the null subcarrier-induced errors become more significant than the noise-induced errors when the SNR is high. Therefore, the conventional TDT approach is not applicable to high SNR conditions.

In addition, the conventional channel estimation is performed based on pilot symbols, (i.e., known preambles or training sequences). Since the pilot symbols are assigned to the small number of subcarriers, some type of interpolation is performed to generate channel estimates for the whole subcarriers based on the channel estimates of the pilot subcarriers. However, the channel estimation using interpolation produces large errors for the frequency selective channels.

### SUMMARY

The present invention is related to a method and apparatus for channel estimation in an OFDM system. A frequency domain channel estimate Ĥ is computed for non-nullified subcarriers. An inverse Fourier transform on the frequency domain channel estimate Ĥ is performed to obtain a time domain channel estimate ĥ. The number of taps L of a channel model is determined based on the time domain channel estimate ĥ. An improved time domain channel estimate \tilde{h} is obtained by computing L tap coefficients of the channel model from the frequency domain channel estimate Ĥ. An improved frequency domain channel estimate \tilde{H} is obtained by performing a Fourier transform on the improved time domain channel estimate \tilde{h}. Alternatively, a time domain truncation may be performed selectively only if the SNR is below a threshold. Alternatively, a frequency domain channel estimate Ĥₚ for all pilot subcarriers are converted to a time domain channel estimate ĥ, and an improved frequency domain channel estimate may be obtained based on the number of pilot subcarriers and a delay spread.

### BRIEF DESCRIPTION OF THE DRAWINGS

FIG. 1 is a flow diagram of a channel estimation process in accordance with a first embodiment of the present invention.

FIGS. 2A and 2B show channel estimation results of a typical B channel at SNR=10 dB in accordance with the present invention and conventional methods.

FIGS. 3A and 3B show a mean square error (MSE) of channel estimation for TGn channels B and D, respectively, in a 2×2 MIMO case in accordance with the present invention and conventional methods.

FIG. 4 is a block diagram of a channel estimation apparatus in accordance with the first embodiment of the present invention.

FIG. 5 is a flow diagram of a channel estimation process in accordance with a second embodiment of the present invention.

FIG. 6 shows simulation results based on IEEE 802.11n TGn channel B.

FIG. 7 is a flow diagram of a channel estimation process in accordance with a third embodiment of the present invention.

### DETAILED DESCRIPTION OF THE PREFERRED EMBODIMENTS

The channel estimation method of the present invention may be implemented in a wireless transmit/receive unit (WTRU) or a base station. The terminology “WTRU” includes but is not limited to a user equipment (UE), a mobile station, a fixed or mobile subscriber unit, a pager, a cellular telephone, a personal digital assistant (PDA), a computer, or any other type of user device capable of operating in a wireless environment. The terminology “base station” includes but is not limited to a Node-B, a site controller, an access point (AP), or any other type of interfacing device capable of operating in a wireless environment.

Hereinafter, the present invention will be explained with reference to an IEEE 802.11n system as an example. However, it should be noted the reference to IEEE 802.11n system is only for illustration, not as a limitation, and the present invention is applicable to any OFDM-based wireless communication systems.

The present invention provides a model-based channel estimation method to circumvent the null subcarriers-induced errors. In the model-based method, the channel is modeled as a tapped delay line. The tap coefficients of the tapped delay line are obtained using a least square approach in the time domain. As long as there are more non-null subcarriers than the number of taps, the model-based approach of the present invention works well for all SNRs.

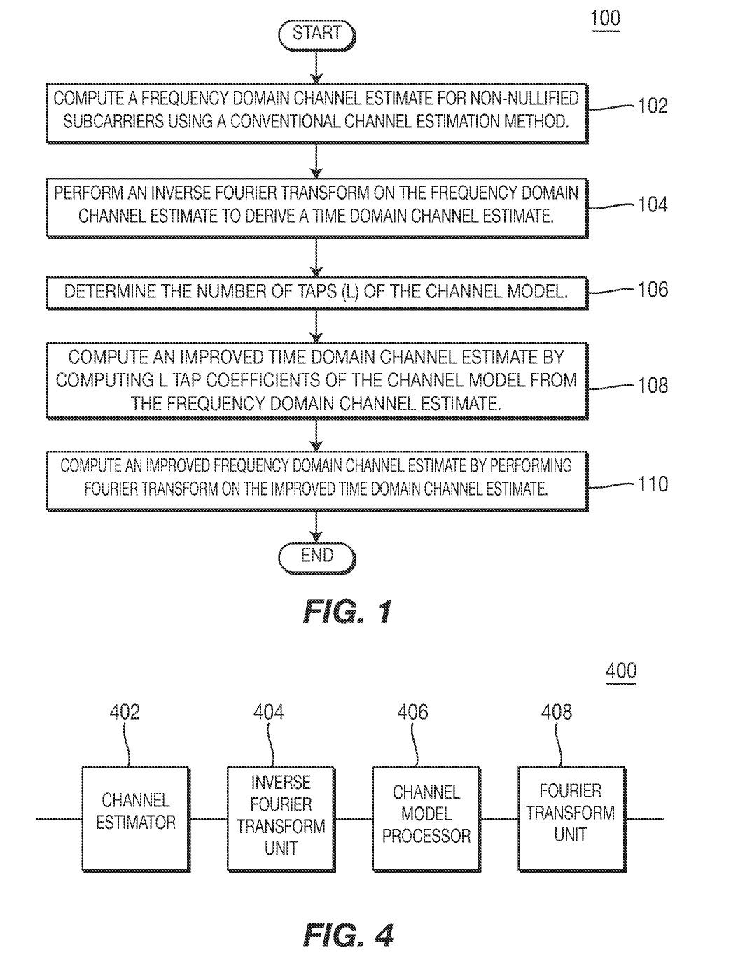

FIG. 1 is a flow diagram of a channel estimation process 100 in accordance with a first embodiment of the present invention. A frequency domain channel estimate Ĥ for non-nullified subcarriers is computed using a conventional channel estimation method, such as an ML method (step 102). A frequency domain interpolation may optionally be performed for the nullified subcarriers. An inverse Fourier transform on the frequency domain channel estimate Ĥ is performed to derive a time domain channel estimate ĥ (step 104). The number of taps (L) of the channel model is then determined (step 106). The number of taps (L) may be determined from an estimated maximum delay spread. If the SNR on the channel is known, a threshold may be chosen for the minimum time domain channel estimate element hᵢⱼ to determine the maximum delay spread.

After the number of taps (L) is determined, the tap coefficients of the channel impulse response may be expressed in terms of the estimated channel transfer functions and an improved time domain channel estimate \tilde{h} is obtained by computing L tap coefficients of the channel model from the frequency domain channel estimate Ĥ, which will be explained in detail hereinafter (step 108). After computing the improved time domain channel estimate \tilde{h}, an improved frequency domain channel estimate \tilde{H} is computed by performing a Fourier transform on the improved time domain channel estimate \tilde{h} (step 110).

The process 100 is explained in detail with exemplary reference to the mathematical equations hereinafter. For the k^{th} sub-carrier, let Hᵢⱼ(k) denote frequency domain channel estimate, (i.e., channel transfer function), for the i^{th} receive antenna and the j^{th} transmit antenna. For a 20 MHz bandwidth in the IEEE 802.11n standard, 64 sub-carriers (k=0, 1, 2, . . . , 63) are used. A time domain channel estimate hᵢⱼ (l), (i.e., channel impulse response), is an inverse Fourier transform of a frequency domain channel estimate Hᵢⱼ(k) as follows:

$${h}_{ij} ( l ) = \frac{1}{N} {\sum }_{k = 0}^{63} {H}_{ij} ( k ) {ⅇ}^{- j 2 π k l / 64} . \qquad Equation ( 1 )$$

In an IEEE 802.11n 20 MHz mode, l=0, 1, 2, . . . , 63 and the sampling interval is 50 nsec.

In one example for an IEEE 802.11n system, a high throughput long training field (HT-LTF) is used to estimate a channel matrix where the transmit antennas are excited one at a time for each sub-carrier. After OFDM demodulation, the estimation of Hᵢⱼ(k) can be formulated as follows:
rᵢ(k)=Hᵢⱼ(k)sⱼ(k)+nᵢ(k); Equation (2)
where sⱼ(k) is the j^{th} transmit training signal, rᵢ(k) is the i^{th} received signal, and nᵢ(k) is the i^{th} received noise. If the noise is Gaussian, the frequency domain channel estimate may be given as follows:
Ĥᵢⱼ(k)=rᵢ(k)/sⱼ(k) Equation (3)

Since sⱼ(k) is non-zero for only 56 sub-carriers, (k=1˜28 and 36˜63), and eight (8) subcarriers, (k=0 and 29˜35), are nullified in an IEEE 802.11n 20 MHz mode, the frequency domain channel estimate in Equation (3) can be derived for only 56 sub-carriers at step 102.

At step 104, a time domain channel estimate ĥᵢⱼ(l) is derived by performing an inverse Fourier transform on the frequency domain channel estimate Ĥᵢⱼ(k) in Equation (3) over the 56 sub-carriers as follows:

$${\hat{h}}_{ij} ( l ) = \frac{1}{N} ( {\sum }_{k = 1}^{28} + {\sum }_{k = 36}^{63} ) {\hat{H}}_{ij} ( k ) {ⅇ}^{- j 2 π k l} . \qquad Equation ( 4 )$$

To improve the time domain channel estimate in Equation (4), a frequency domain interpolation and/or extrapolation may optionally be performed to provide approximately the frequency domain channel estimate Ĥᵢⱼ(k) at the null sub-carriers (k=0 and 29˜35).

At step 106, the number of taps (L) of the tapped delay line of the channel model is determined. The number of taps may be derived from an estimated maximum delay spread (T_{T}), (i.e., T_{T}=L×50 nsec). If the SNR on the channel is known, a threshold for time domain channel estimate element hᵢⱼ may be chosen based on the SNR and the maximum delay spread may be determined by comparing the threshold with the elements of the time domain channel estimate. The number of taps may be determined by many different ways.

When the number of taps (L) is determined, the tap coefficients of the channel model can be expressed in terms of the frequency domain channel estimate as follows:

$${\hat{H}}_{ij} ( k ) \approx {H}_{ij} ( k ) = {\sum }_{l = 0}^{63} {h}_{ij} ( l ) {ⅇ}^{j 2 π k l} \approx {\sum }_{l = 0}^{L - 1} {h}_{ij} ( l ) {ⅇ}^{j 2 π k l} . \qquad Equation ( 5 )$$

If the number of taps (L) is less than the frequency domain channel estimates, (e.g., 56 in an IEEE 802.11n 20 MHz mode), an improved time domain channel estimate may be obtained by solving the tap coefficients directly from Equation (5) at step 108. Equation (5) may be rewritten as follows:
Ĥᵢⱼ≈Fhᵢⱼ, Equation (6)
wherein hᵢⱼ is an L×1 vector for L unknown tap coefficients, Ĥᵢⱼ is a 56×1 vector of the 56 estimated channel transfer functions, and F is a 56×L Fourier transform matrix. F does not depend on the antenna indexes ij. The least square solution of Equation (6) is as follows:
\tilde{h}ᵢⱼ=(F^{H}F)⁻¹F^{H}Ĥᵢⱼ; Equation (7)
and the l^{th} element of the improved time domain channel estimate is approximated by the l^{th} element of \tilde{h}ᵢⱼ in Equation (7).

At step 110, an improved frequency domain channel estimate is obtained by performing Fourier transform on the improved time domain channel estimate as follows:

$${H}_{ij} ( k ) \approx {\tilde{H}}_{ij} ( k ) = {\sum }_{l = 0}^{L - 1} {\tilde{h}}_{ij} ( l ) {ⅇ}^{j 2 π k l} . \qquad Equation ( 8 )$$

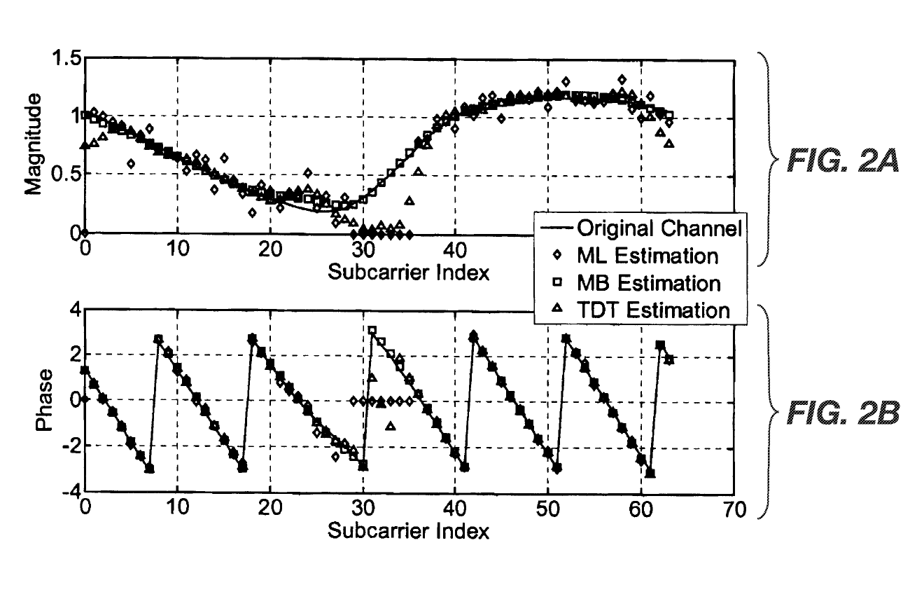

FIGS. 2A and 2B show channel estimation results of a typical B channel at SNR=10 dB in accordance with the first embodiment of the present invention and conventional methods. The solid line is the original channel transfer function. The model-based method of the present invention has the best estimation accuracy for all subcarriers and the ML results are the worst. Even at null subcarriers, the model-based results are very close to the true channel value but the ML and TDT methods cannot provide accurate channel information.

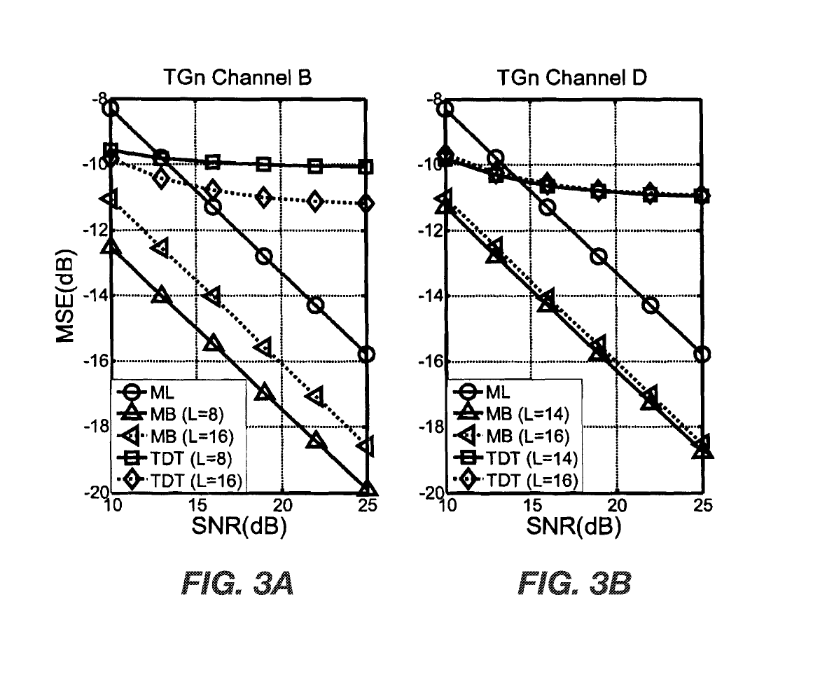

FIGS. 3A and 3B show an MSE of channel estimation for TGn channels B and D, respectively, in a 2×2 MIMO case in accordance with the first embodiment of the present invention and conventional methods. The MSE for channel estimations is defined as follows:

$$MSE = mean \{ {\sum }_{i} {\sum }_{j} {\sum }_{k} {\vert {{H}^{⋒}}_{ij} ( k ) - {H}_{ij} ( k ) \vert}^{2} \} ; \qquad Equation ( 9 )$$

where Ĥᵢⱼ(k) represents the estimated channel transfer function. The mean in Equation (9) is made over 2,000 channel realizations.

In the simulations, two values of maximum delay spread are chosen for each channel model. The maximum delay spread is 400 nsec or 800 nsec for channel B, and 700 nsec or 800 nsec for channel D. In other words, the maximum number of taps (L) is 8 or 16 for channel B, and 14 or 16 for channel D. Since the two L values for channel D are close to each other, the MSE results derived by these two values are also close to each other for both TDT and model-based methods. However, the MSE results are very different for channel B.

For the model-based method of the present invention, using a smaller L removes more noises and the optimum L is when the maximum delay spread is equal to the effective channel delay spread. It is not the case for the TDT approach. Although a smaller L still removes more noises, it also magnifies the effects due to null carrier frequencies. Thus, a small L is not necessary better for the TDT method. An optimum L will be usually greater than the effective channel length.

Comparing to the model-based result with L=8, the ML result is 4 dB worse (i.e., higher) for all SNRs for channel B. Comparing to the TDT result with L=16, the ML result is 2 dB worse at SNR=10 dB but is 5 to 6 dB better at SNR=25 dB for channel B. For channel D, the ML result is 3 dB worse than the model-based result for all SNRs. It is 2 dB worse at SNR=10 dB but is 5 dB better at SNR=25 dB than the TDT result. Thus, the model-based approach provides the best results (smallest MSE) for all situations. TDT is a simplified version of ML. It provides smaller MSE than ML at low SNRs.

FIG. 4 is a block diagram of a channel estimation apparatus 400 in accordance with a first embodiment of the present invention. The apparatus 400 comprises a channel estimator 402, an inverse Fourier transform unit 404, a channel model processor 406 and a Fourier transform unit 408. The channel estimator 402 computes a frequency domain channel estimate Ĥ for non-nullified subcarriers. The inverse Fourier transform unit 404 performs an inverse Fourier transform on the frequency domain channel estimate Ĥ to obtain a time domain channel estimate ĥ. The channel model processor 406 determines the number of taps L of a channel model and computing an improved time domain channel estimate \tilde{h} by computing L tap coefficients of the channel model from the frequency domain channel estimate Ĥ. The Fourier transform unit 408 then computes an improved frequency domain channel estimate \tilde{H} by performing Fourier transform on the improved time domain channel estimate \tilde{h}.

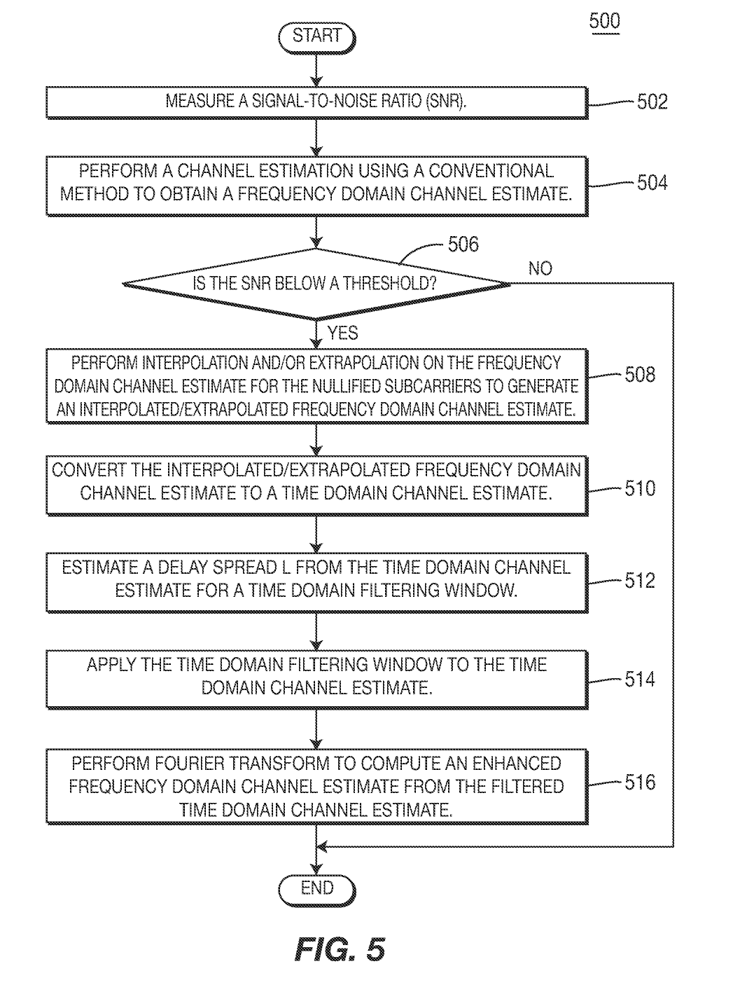

FIG. 5 is a flow diagram of a channel estimation process 500 in accordance with a second embodiment of the present invention. An OFDM system comprises N subcarriers among which M subcarriers are used for data and pilot transmission and (N-M) subcarriers, (e.g., center subcarriers and subcarriers at both edges which form the guard bands), are nullified.

An SNR is measured (step 502). A channel estimation is then performed using a conventional method, (such as ML or MMSE estimation), to obtain a frequency domain channel estimate Ĥ (step 504). The SNR is compared to a threshold (step 506). If the SNR is not below the threshold, the process 500 stops.

If the SNR is below the threshold, interpolation and/or extrapolation is performed on the frequency domain channel estimate Ĥ for the nullified subcarriers to generate an interpolated/extrapolated frequency domain channel estimate \hat{Ĥ} (step 508). For simplicity, the frequency domain channel estimate of the adjacent subcarrier may be copied to the nullified subcarrier. The interpolated/extrapolated frequency domain channel estimate \hat{Ĥ} is then converted to a time domain channel estimate, \hat{ĥ}=IFFT(\hat{Ĥ}) (step 510). A delay spread L is then estimated from the time domain channel estimate \hat{ĥ} for a time domain filtering window W_{L}=[11 . . . 100 . . . 0]^{T} (step 512). The number of is in the time domain filtering window equals to L. The time domain filtering window is applied to the time domain channel estimate \hat{ĥ} such that \tilde{h}=\hat{ĥ}·W_{L}, (i.e. zeroing the components of \tilde{h} on the outside of the delay spread window) (step 514). An enhanced frequency domain channel estimate \tilde{H} is computed from the filtered time domain channel estimate \tilde{h} by performing Fourier transform such that \tilde{H}=FFT(\tilde{H}) (step 516).

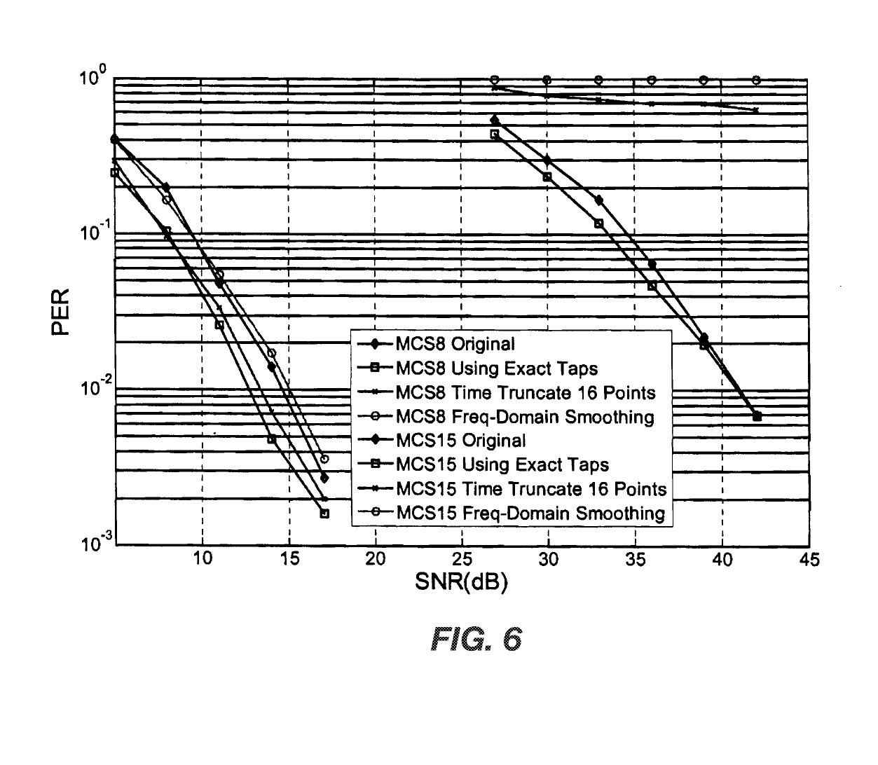

FIG. 6 shows simulation results based on IEEE 802.11n TGn channel B. As shown in FIG. 6, the channel estimation method in accordance with the second embodiment of the present invention provides an enhanced channel estimation at a low SNR for the OFDM systems (IEE802.11n alike).

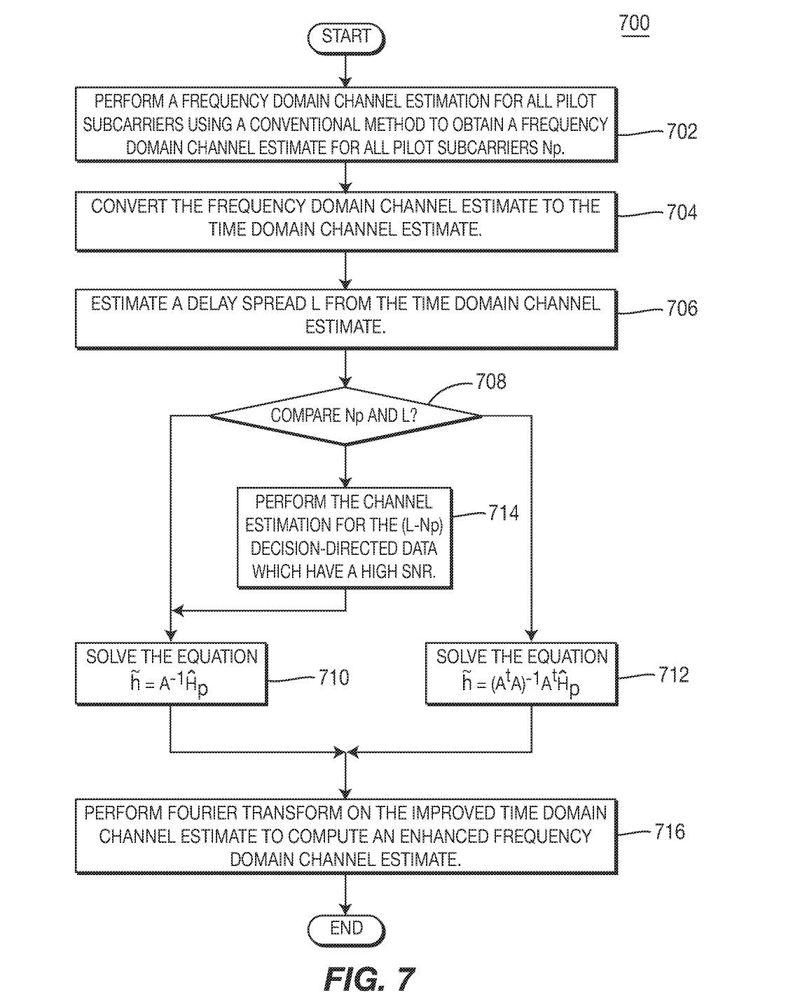

FIG. 7 is a flow diagram of a channel estimation process 700 in accordance with a third embodiment of the present invention. In accordance with the third embodiment, a channel estimation is performed based on pilot subcarriers. A frequency domain channel estimation is performed for all pilot subcarriers using a conventional method to obtain a frequency domain channel estimate Ĥₚ for all pilot subcarriers Nₚ (step 702). The frequency domain channel estimate Ĥₚ is converted to the time domain channel estimate, ĥ=IFFT(Ĥₚ) (step 704). A delay spread (L) is then estimated from the time domain channel estimate (step 706).

Nₚ and L are compared at step 708 and an improved time domain channel estimate \tilde{h} is estimated depending on the number of pilot subcarriers Nₚ and the delay spread L as follows. If Nₚ=L, the following equation is solved: \tilde{h}=A⁻¹Ĥₚ, (i.e., Ĥₚ=A\tilde{h}), where A is (Nₚ×L), Ĥₚ is (Nₚ×1), and \tilde{h} is (L×1) (step 710). The row of A is the Fourier transform coefficients corresponding to the pilot subcarrier. If Nₚ>L, the following equation is solved: \tilde{h}=(A^{t}A)⁻¹A^{t}Ĥₚ (step 712). If Nₚ<L, the channel estimation is performed for the (L-Nₚ) decision-directed data which have a high SNR (step 714) and the process 700 proceeds to step 710. An enhanced frequency domain channel estimation \tilde{H} is then computed by performing Fourier transform on the improved time domain channel estimate \tilde{h}, \tilde{H}=FFT(\tilde{h}) (step 716).

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. In an orthogonal frequency division multiplexing (OFDM) system using a plurality of subcarriers wherein at least one subcarrier is nullified, a method for channel estimation, the method comprising:
computing a frequency domain channel estimate Ĥ for non-nullified subcarriers;
performing an inverse Fourier transform on the frequency domain channel estimate Ĥ to obtain a time domain channel estimate ĥ;
determining the number of taps L of a channel model based on the time domain channel estimate ĥ;
computing an improved time domain channel estimate \tilde{h} by computing L tap coefficients of the channel model from the frequency domain channel estimate Ĥ; and
computing an improved frequency domain channel estimate \tilde{H} by performing Fourier transform on the improved time domain channel estimate \tilde{h}.

2. The method of claim 1 further comprising:
adding a frequency domain channel estimate of the nullified subcarrier to the frequency domain channel estimate Ĥ.

3. The method of claim 2 wherein the channel estimate of the nullified subcarrier is added by copying a channel estimate of an adjacent subcarrier.

4. The method of claim 2 wherein the channel estimate of the nullified subcarrier is added by one of interpolating and extrapolating channel estimates of adjacent subcarriers.

5. The method of claim 1 wherein the number of taps is determined based on an estimated maximum delay spread.

6. The method of claim 5 further comprising:
computing a signal-to-noise ratio (SNR);
selecting a threshold based on the SNR; and
determining the maximum delay spread by comparing elements of the time domain channel estimate ĥ to the threshold.

7. In an orthogonal frequency division multiplexing (OFDM) system using a plurality of subcarriers wherein at least one subcarrier is nullified, an apparatus for channel estimation, the apparatus comprising:
a channel estimator for computing a frequency domain channel estimate Ĥ for non-nullified subcarriers;
an inverse Fourier transform unit for performing an inverse Fourier transform on the frequency domain channel estimate Ĥ to obtain a time domain channel estimate ĥ;
a channel model processor for determining the number of taps L of a channel model and computing an improved time domain channel estimate \tilde{h} by computing L tap coefficients of the channel model from the frequency domain channel estimate Ĥ; and
a Fourier transform unit for computing an improved frequency domain channel estimate \tilde{H} by performing Fourier transform on the improved time domain channel estimate \tilde{h}.

8. The apparatus of claim 7 wherein the channel estimator adds a frequency domain channel estimate of the nullified subcarrier to the frequency domain channel estimate Ĥ.

9. The apparatus of claim 8 wherein the channel estimator adds the channel estimate of the nullified subcarrier by copying a channel estimate of an adjacent subcarrier.

10. The apparatus of claim 8 wherein the channel estimator adds the channel estimate of the nullified subcarrier by one of interpolating and extrapolating channel estimates of adjacent subcarriers.

11. The apparatus of claim 7 further comprising:
a maximum delay spread estimator for estimating a maximum delay spread, wherein the channel model processor determines the number of taps based on the estimated maximum delay spread.

12. The apparatus of claim 11 further comprising:
a signal-to-noise ratio (SNR) calculator for computing an SNR;
a threshold selector for selecting a threshold based on the SNR; and
a comparator for comparing elements of the time domain channel estimate to the threshold to estimate the maximum delay spread.

13. In an orthogonal frequency division multiplexing (OFDM) system using a plurality of subcarriers wherein at least one subcarrier is nullified, a method for channel estimation, the method comprising:
measuring a signal-to-noise ratio (SNR);
comparing the SNR to a threshold;
computing a frequency domain channel estimate only if the SNR is below the threshold;
adding channel estimate for the nullified subcarrier to the frequency domain channel estimate to generate a second frequency domain channel estimate;
converting the second frequency domain channel estimate to a time domain channel estimate;
estimating a delay spread from the time domain channel estimate for generating a time domain filtering window;
applying the time domain filtering window to the time domain channel estimate to obtain a filtered time domain channel estimate; and
performing Fourier transform on the filtered time domain channel estimate to obtain an enhanced frequency domain channel estimate.

14. The method of claim 13 wherein the channel estimate for the nullified subcarrier is added by copying a channel estimate of an adjacent subcarrier.

15. The method of claim 13 wherein the channel estimate for the nullified subcarrier is added by one of interpolating and extrapolating channel estimates of adjacent subcarriers.

16. In an orthogonal frequency division multiplexing (OFDM) system using a plurality of subcarriers wherein at least one subcarrier is nullified, an apparatus for channel estimation, the apparatus comprising:
a signal-to-noise ratio (SNR) measurement unit for measuring an SNR;
a threshold unit for comparing the SNR to a threshold;
a channel estimator for computing a frequency domain channel estimate only if the SNR is below the threshold;
a processing unit for adding channel estimate for the nullified subcarrier to the frequency domain channel estimate to generate a second frequency domain channel estimate;
an inverse Fourier transform unit for converting the second frequency domain channel estimate to a time domain channel estimate;
a delay spread calculator for estimating a delay spread from the time domain channel estimate for generating a time domain filtering window;
a filter for applying the time domain filtering window to the time domain channel estimate to obtain a filtered time domain channel estimate; and
a Fourier transform unit for performing Fourier transform on the filtered time domain channel estimate to obtain an enhanced frequency domain channel estimate.

17. The apparatus of claim 16 wherein the channel estimate for the nullified subcarrier is added by copying a channel estimate of an adjacent subcarrier.

18. The apparatus of claim 16 wherein the channel estimate for the nullified subcarrier is added by one of interpolating and extrapolating channel estimates of adjacent subcarriers.

19. In an orthogonal frequency division multiplexing (OFDM) system using a plurality of subcarriers wherein at least one subcarrier is nullified, a method for channel estimation, the method comprising:
computing a frequency domain channel estimate Ĥₚ for all pilot subcarriers;
converting the frequency domain channel estimate Ĥₚ to a time domain channel estimate ĥ;
estimating a delay spread L from the time domain channel estimate ĥ;
if the number of pilot subcarriers is same to the delay spread, solving the equation: \tilde{h}=A⁻¹Ĥₚ, where A is (Nₚ×L), Ĥₚ is (Nₚ×1), and \tilde{h} is (L×1) to obtain an improved time domain channel estimate \tilde{h}, the row of A is Fourier transform coefficients corresponding to the pilot subcarrier; and
converting the improved time domain channel estimate \tilde{h} to an improved frequency domain channel estimate \tilde{H}.

20. The method of claim 19 further comprising:
if the number of pilot subcarriers is greater than the delay spread, solving the equation \tilde{h}=(A^{t}A)⁻¹A^{t}Ĥₚ to obtain the improved time domain channel estimate \tilde{h}.

21. The method of claim 19 further comprising:
if the number of pilot subcarriers is smaller than the delay spread, performing channel estimation for the (L-Nₚ) decision-directed data which have a high signal-to-noise ratio (SNR).

22. In an orthogonal frequency division multiplexing (OFDM) system using a plurality of subcarriers wherein at least one subcarrier is nullified, an apparatus for channel estimation, the apparatus comprising:
a channel estimator for computing a frequency domain channel estimate Ĥₚ for all pilot subcarriers;
an inverse Fourier transform unit for converting the frequency domain channel estimate Ĥₚ to a time domain channel estimate ĥ;
a delay spread calculator for estimating a delay spread L from the time domain channel estimate ĥ;
a processor for solving the equation: \tilde{h}=A⁻¹Ĥₚ if the number of pilot subcarriers Nₚ is same to the delay spread, where A is (Nₚ×L), Ĥₚ is (Nₚ×1), and \tilde{h} is (L×1) to obtain an improved time domain channel estimate \tilde{h}, the row of A is Fourier transform coefficients corresponding to the pilot subcarrier; and
a Fourier transform unit for converting the improved time domain channel estimate \tilde{h} to an improved frequency domain channel estimate \tilde{H}.

23. The apparatus of claim 22 wherein, if the number of pilot subcarriers is greater than the delay spread, the processor solves the equation \tilde{h}=(A^{t}A)⁻¹A^{t}Ĥₚ to obtain the improved time domain channel estimate \tilde{h}.

24. The apparatus of claim 22 wherein, if the number of pilot subcarriers is smaller than the delay spread, the channel estimator performs channel estimation for the (L-Nₚ) decision-directed data which have a high signal-to-noise ratio (SNR).
